(19) United States
(12) Patent Application Publication
(10) Pub. No.: US 2025/0210338 A1
(43) Pub. Date: Jun. 26, 2025

(54) MASS SPECTROMETER

(71) Applicant: SHIMADZU CORPORATION, Kyoto-shi (JP)

(72) Inventor: Masaru NISHIGUCHI, Kyoto-shi (JP)

(21) Appl. No.: 18/975,434

(22) Filed: Dec. 10, 2024

(30) Foreign Application Priority Data
Dec. 21, 2023 (JP) 2023-216014

(51) Int. Cl. H01J 49/42; H01J 49/40

(52) U.S. Cl. CPC H01J 49/4225; H01J 49/401; H01J 49/421

(57) ABSTRACT

In a mass spectrometer, a linear ion trap unit (2) has an ion-capturing space formed by rod electrodes (20) surrounding a central axis (C) and an auxiliary electrode (21) provided outside an ion-ejection end of the rod electrodes or protruding from the ion-ejection end. An extracting electrode (23) is located further outside the auxiliary electrode. An RF voltage generator (50) applies RF voltages to the rod electrodes and the auxiliary electrode to create an RF electric field within the ion-capturing space. An extracting voltage generator (52) applies a DC voltage to the extracting electrode so that a DC electric field for ion extraction reaches the ion-capturing space. A controller (4) controls the RF and extracting voltage generators to eject ions from the ion-capturing space along the central axis according to their m/z by changing the RF voltage or the DC voltage when the ions are confined within the ion-capturing space.

### TECHNICAL FIELD

The present invention relates to a mass spectrometer.

### BACKGROUND ART

A mass spectrometer which uses an ion trap that spatially confines ions by the effect of an electric field has been conventionally known. This type of ion trap can be roughly divided into a liner ion trap and a three-dimensional quadrupole ion trap (which is also called a “Paul trap”). As compared to three-dimensional quadrupole ion traps, linear ion traps have such advantages as the ease of production due to the comparatively simple shape of the electrodes as well as the large capacity of the ion-capturing space which can hold a larger amount of ions.

Ion traps are not only capable of holding ions; they can also have a mass-separating (or mass-selecting) function for releasing the held ions to the outside of the trap while separating those ions according to their mass-to-charge ratios (m/z). For the mass separation within an ion trap, resonance excitation ejection is normally employed (see Patent Literature 1 or other related documents). In the resonance excitation ejection in a linear ion trap, while an RF voltage for confining ions within the ion-capturing space is applied to each of the rod electrodes, an ion-excitation alternating-current (AC) voltage for exciting ions having a specific m/z is additionally applied to specific rod electrodes. This causes only an ion having that specific m/z to be selectively oscillated with a large amplitude and ultimately released to the outside through an opening formed in one of the rod electrodes among the various kinds of ions captured within the ion-capturing space due to the effect of the RF electric field.

The mass spectrometer disclosed in Patent Literature 1 is an orthogonal ejection type of linear ion trap in which ions held in the linear ion trap are ejected in an orthogonal direction to the ion beam axis (central axis) of the same linear ion trap. On the other hand, as disclosed in Patent Literature 2, an axial ejection type of linear ion trap has also been known in which ions are ejected in the same direction as the ion beam axis, i.e., in the axial direction, by means of the resonance excitation ejection. An advantage of the axial ejection type of linear ion trap exists, for example, in that its ion beam axis can be coincident with that of the multipole ion guide, mass filter and other ion optical devices located in the subsequent stages, which makes it easier to arrange those ion optical devices.

### CITATION LIST

### Patent Literature

Patent Literature 1: JP 2018-73703 A
Patent Literature 2: WO 2023/203620 A
Patent Literature 3: JP 2020-35726 A
Patent Literature 4: WO 2020/129199 A

### SUMMARY OF INVENTION

### Technical Problem

Resonance excitation ejection can achieve the mass separation of ions with a comparatively high level of mass-resolving power. However, resonance excitation ejection requires applying the ion-excitation AC voltage to a rod electrode in addition to the RF voltages. Therefore, for example, as described in Patent Literature 3, the power supply device for applying voltages to the rod electrodes has a complex configuration. This poses problems, such as the entire device being larger in size and heavier in weight, as well as the power source being overly expensive.

The present invention has been developed to solve such problems. One of its objectives is to provide a mass spectrometer including a linear ion trap which can simultaneously perform axial ejection with a mass scan using a power supply device with a simple configuration.

### Solution to Problem

One mode of the mass spectrometer according to the present invention developed for solving the previously described problem includes:
a linear ion trap unit including: a plurality of rod electrodes arranged so as to surround a central axis; an auxiliary electrode surrounding the central axis, or having the central axis in between, and provided outside an ion-ejection end of the plurality of rod electrodes or protruding from the ion-ejection end; and an extracting electrode located further outside the auxiliary electrode;
an RF voltage generator configured to apply an RF voltage to the plurality of rod electrodes and the auxiliary electrode in order to create an RF electric field within an ion-capturing space surrounded by the plurality of rod electrodes and the auxiliary electrode;
an extracting voltage generator configured to apply a DC voltage to the extracting electrode so that a DC electric field for ion extraction reaches the ion-capturing space; and
a controller configured to control the RF voltage generator and the extracting voltage generator so as to eject ions from the ion-capturing space in a direction along the central axis according to the mass-to-charge ratios of the ions by changing at least the RF voltage or the DC voltage when the ions are confined within the ion-capturing space.

### Advantageous Effects of Invention

The previously described mode of the mass spectrometer according to the present invention does not require applying two different types of alternating-current voltages, i.e., the RF and AC voltages, to the rod electrodes in a superposed fashion as in the resonance excitation ejection. Therefore, by the previously described mode of the mass spectrometer according to the present invention, it is possible to simplify the configuration of the power supply device for driving the linear ion trap and yet realize a mass scan for axially releasing ions from the linear ion trap in order of their mass-to-charge ratios. The power supply device can consequently be smaller in size and lighter in weight, as well as less expensive. Furthermore, since ions are ejected in the axial direction of the linear ion trap, it is possible to arrange ion optical devices, such as a quadrupole mass filter or multipole ion guide, in the subsequent stages so that their ion beam axis coincides with that of the linear ion trap. This facilitates the task of arranging the ion optical devices.

### BRIEF DESCRIPTION OF DRAWINGS

FIG. 1 is a schematic perspective view showing the structure of rod electrodes in one embodiment of a linear ion trap to be used in a mass spectrometer according to the present invention.

FIG. 2 is a diagram illustrating the structure of the rod electrodes shown in FIG. 1.

FIGS. 3A, 3B and 3C are a schematic vertical sectional front view, a sectional view at the arrowed line A-AA, and a sectional view at the arrowed line B-BB of the linear ion trap in the present embodiment, respectively.

FIG. 4 is a schematic configuration diagram of a mass spectrometer using the linear ion trap shown in FIGS. 3A-3C.

FIG. 5 is a diagram showing one example of the simulation result of an ion trajectory in the linear ion trap according to the present embodiment.

FIG. 6 is a timing chart showing one example of the change in the voltages applied for driving the linear ion trap (in the case of varying the RF voltage).

FIG. 7 is a timing chart showing another example of the change in the voltages applied for driving the linear ion trap (in the case of varying the extracting DC voltage).

FIG. 8 is a graph showing one example of the calculated result of the relationship between the RF voltage and the ion extraction efficiency in the linear ion trap according to the present embodiment.

FIG. 9 is a graph showing one example of the calculated result of the relationship between the m/z value of ions and the ion extraction efficiency in the linear ion trap according to the present embodiment.

FIG. 10 is a diagram showing a configuration example of a mass spectrometer using the linear ion trap according to the present embodiment.

FIG. 11 is one example of the timing chart in the mass spectrometer shown in FIG. 10.

FIG. 12 is a diagram showing another configuration example of a mass spectrometer using the linear ion trap according to the present embodiment.

FIG. 13 is a diagram showing still another configuration example of a mass spectrometer using the linear ion trap according to the present embodiment.

FIG. 14 is a schematic vertical sectional front view of another example the linear ion trap.

FIG. 15 is a schematic vertical sectional front view of still another example the linear ion trap.

FIG. 16 is a timing chart showing one example of the change in the voltages applied for driving the linear ion trap shown in FIG. 15.

FIG. 17 is a diagram showing one example of the simulation result of an ion trajectory in the still another example of the linear ion trap.

### DESCRIPTION OF EMBODIMENTS

An embodiment of the mass spectrometer according to the present invention and a linear ion trap used in the embodiment are hereinafter described in detail with reference to the attached drawings.

### [Schematic Configuration of Mass Spectrometer]

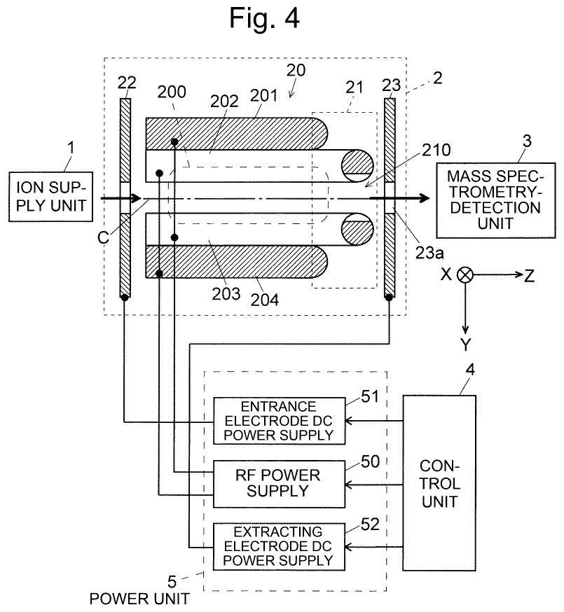

FIG. 4 is a schematic configuration diagram of one example of the mass spectrometer according to the present invention. For convenience of explanation, the three axes of X, Y and Z which are orthogonal to each other are defined within a space in FIG. 4 and other drawings.

The present mass spectrometer includes an ion supply unit 1, linear ion trap 2, mass spectrometry-detection unit 3, control unit 4 and power unit 5. Though not shown, the ion supply unit 1, linear ion trap 2 and mass spectrometry-detection unit 3 may be provided within a vacuum chamber or similar container.

The ion supply unit 1, which includes an ion source and other related components, is configured to ionize various components contained in a sample and supply the resulting ions to the linear ion trap 2 in a direction roughly along the ion beam axis C (Z-axis direction). The linear ion trap 2, which includes a plurality of rod electrodes 201-206 (although only four rods are visible in FIG. 4, there are actually six rods), is operated to temporarily hold ions within the inner space (ion-capturing space) 200 surrounded by the rod electrodes 201-206 and eject the held ions in a direction along the ion beam axis C in descending order of their m/z. In other words, the linear ion trap 2 is an axial ejection type of linear ion trap capable of a mass scan.

The power unit 5 is configured to apply a voltage to each electrode in the linear ion trap 2 under the control of the control unit 4. The mass spectrometry-detection unit 3 has either a configuration including one or more mass separators and a detector, or a configuration including only a detector. In the former case, the mass spectrometry-detection unit 3 receives ions ejected from the linear ion trap 2 and detects those ions after separating them according to their m/z. In the latter case, the mass spectrometry-detection unit 3 directly detects ions ejected from the linear ion trap 2. A specific configuration of the mass spectrometry-detection unit 3 will be shown in configuration examples (which will be described later). The control unit 4, which normally includes a CPU, ROM, RAM and other related elements, is configured to send control signals to the power unit 5 and other related sections to execute analysis operations according to a previously set control program.

### [Configuration of Linear Ion Trap]

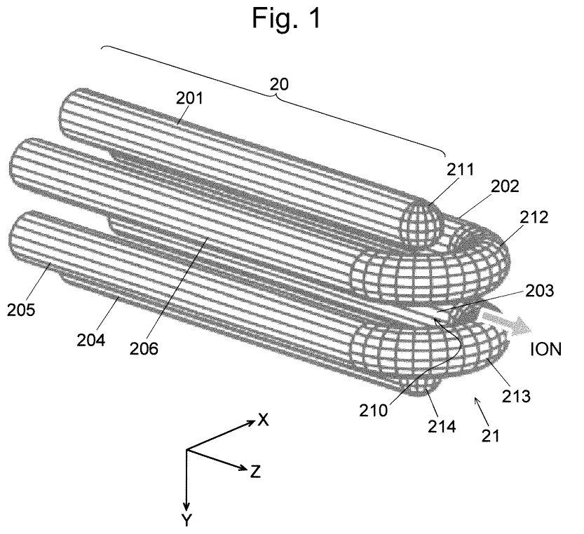

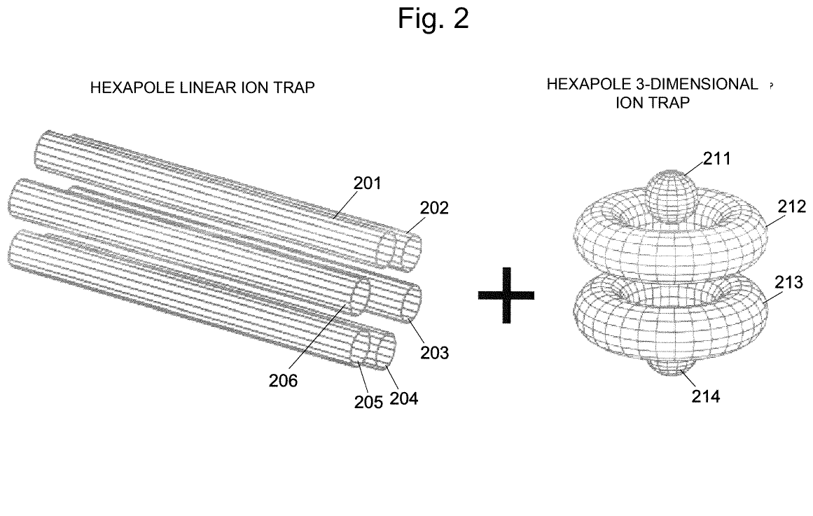

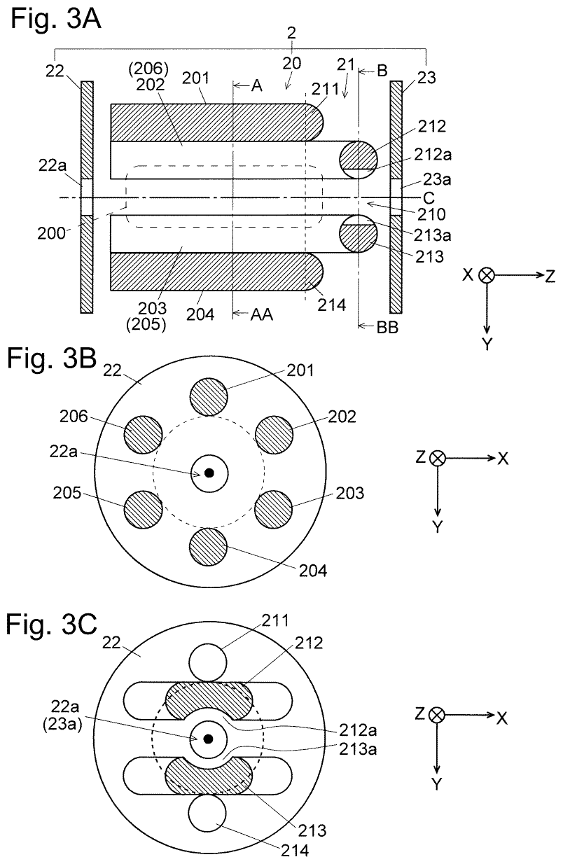

FIGS. 3A-3C are diagrams for detailed descriptions of the electrode structure of the linear ion trap 2 in FIG. 4, where FIG. 3A is a schematic vertical sectional front view, FIG. 3B is a sectional view at the arrowed line A-AA in FIG. 3A, and FIG. 3C is a sectional view at the arrowed line B-BB in FIG. 3A. FIG. 1 is a schematic perspective view showing the structure of the rod electrodes. FIG. 2 is an auxiliary diagram for describing the structure of those rod electrodes.

As shown in FIG. 3, the linear ion trap 2 includes the following components: a rod-electrode group 20 consisting of six rod electrodes 201, 202, 203, 204, 205 and 206 arranged so as to surround a straight ion beam axis C extending in the Z-axis direction; a three-dimensional ion trap partial electrode 21 located at the ion-ejection end (in the present drawing, the right end) of the rod-electrode group 20 and provided continuously from (and electrically connected to) each of the rod electrodes 201-206; a substantially disk-shaped entrance end-cap electrode 22 having a circular opening 22a at its center and located outside the ion-injection end (in the present drawing, the left end) of the rod-electrode group 20; and a disk-shaped extracting electrode 23 having a substantially circular opening 23a and located outside the three-dimensional ion trap partial electrode 21. The extracting electrode 23 doubles as an exit end-cap electrode in a common type of linear ion trap.

As shown in FIG. 3B, the six rod electrodes 201-206 are externally tangent to a circle (drawn by the broken line in the drawing) whose center is located on the ion beam axis C, and are arranged at equal angular intervals (60 degrees) around the ion beam axis C. On the other hand, the three-dimensional ion trap partial electrode 21 is a set of electrodes corresponding to a portion of a hexapole three-dimensional ion trap as shown in FIG. 2 formed by two ring-shaped electrodes 212 and 213 as well as two ball-shaped electrodes 211 and 214 opposing each other across the ring-shaped electrodes; more specifically, it is a set of electrodes obtained by equally dividing these electrodes into two halves at the X-Y plane orthogonal to the ion beam axis C (Z-axis). For the present description, the four electrodes forming the three-dimensional ion trap partial electrode 21 are denoted by the same reference signs as assigned to the ring-shaped and ball-shaped electrodes shown in FIG. 2 in order to clarify their correspondence relationship.

The diameter of the ball-shaped electrodes 211 and 214 is equal to that of the rod electrodes 201 and 204, while the diameter of the ring-shaped electrodes 212 and 213 is equal to that of the rod electrodes 202, 203, 205 and 206. Accordingly, the rod electrode 201 is connected with the ball-shaped electrode 211 in a step-free manner to form a single body, and the same also applies to the rod electrode 204 connected with the ball-shaped electrode 214, the rod electrodes 202 and 206 connected with the ring-shaped electrode 212, as well as the rod electrodes 203 and 205 connected with the ring-shaped electrode 213. In other words, the rod electrodes 202 and 206 combined with the ring-shaped electrode 212 form a U-shaped electrode in their plan view, and the same applies to the rod electrodes 203 and 205 combined with the ring-shaped electrode 213. Meanwhile, the rod electrode 201 combined with the ball-shaped electrode 211 forms a linear electrode with one end having a spherical surface, and the same applies to the rod electrode 204 combined with the ball-shaped electrode 214.

It should be noted that, as shown in FIG. 3C, the two ring-shaped electrodes 212 and 213 opposing each other across the ion beam axis C have removed portions 212a and 213a in the areas facing the ion beam axis C, which are hollows having a columnar shape with the central axis coinciding with the ion beam axis C. These removed portions 212a and 213a, in combination with the gap between the two ring-shaped electrodes 212 and 213 in their original form (i.e., before the removed portions are formed), can function as an ion extraction opening 210 through which a DC electric field created by the extracting electrode 23 penetrates into the ion-capturing space 200 and through which ions are extracted by that electric field, as will be described later.

As shown in FIG. 4, the entrance end-cap electrode 22 can be supplied with a predetermined DC voltage from an entrance electrode DC power supply 51 in the power unit 5. The extracting electrode 23 can be supplied with a predetermined DC voltage from an extracting electrode DC power supply 52. The rod electrodes 201-206 in the rod-electrode group 20 as well as the electrodes 211-241 in the three-dimensional ion trap partial electrode 21 are respectively supplied with predetermined RF voltages from an RF power supply 50. Specifically, the RF voltages applied to the six rod electrodes 201-206 are RF voltages having the same amplitude and frequency, with the polarity inverted (i.e., with a phase shift of 180 degrees) between any two rod electrodes neighboring each other in the circumferential direction. In the present embodiment, since the two rod electrodes 202 and 206, are connected to each other via the ring-shaped electrode 212 while the other two rod electrodes 203 and 205 are connected to each other via the ring-shaped electrode 213, the RF voltages required for all electrodes in the rod-electrode group 20 and the three-dimensional ion trap partial electrode 21 can be applied by merely supplying the four rod electrodes 201, 202, 203 and 204 shown in FIG. 4 with their respective RF voltages.

### [Operation of Linear Ion Trap]

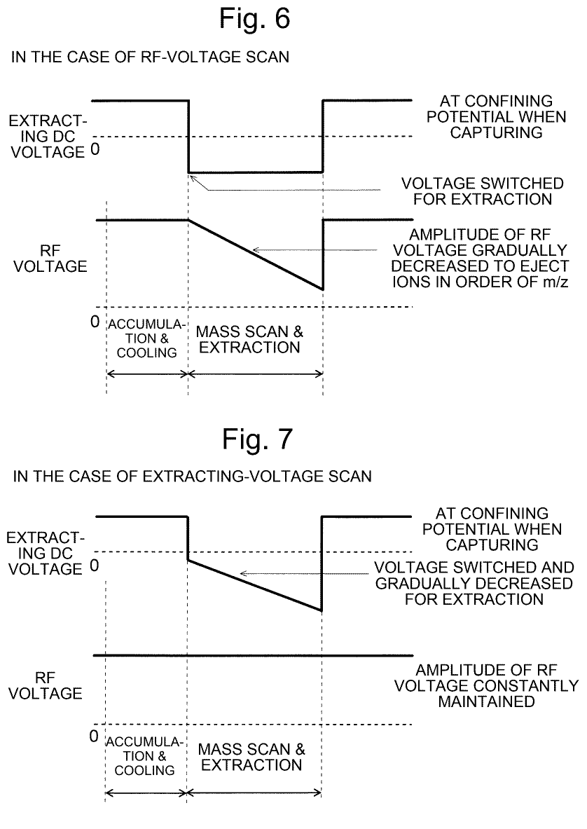

Next, an example of the basic operation of the linear ion trap 2 is described. FIG. 6 is a timing chart showing an example of the change in the voltages applied for driving the linear ion trap 2 in which the RF voltage is varied to perform a mass scan. FIG. 7 is a timing chart showing another example of the change in the voltages applied for driving the linear ion trap 2 in which the extracting DC voltage is varied to perform a mass scan.

In FIG. 4, the ion supply unit 1 sends various ions originating from a sample to be analyzed in a direction roughly along the ion beam axis. The entrance electrode DC power supply 51 applies, to the entrance end-cap electrode 22, a DC voltage which changes at predetermined timings so as to create a DC electric field which allows the ions supplied from the ion supply unit 1 to enter for a predetermined period of time and then blocks the ions in front of the entrance end-cap electrode 22 after the aforementioned period of time has passed. The RF power supply 50 applies predetermined RF voltages to the rod electrodes 201-206 to create, within the ion-capturing space 200, a multipole RF electric field for capturing various ions introduced into the ion-capturing space 200 through the opening 22a of the entrance end-cap electrode 22. The extracting electrode DC power supply 52 applies, to the extracting electrode 23, a DC voltage that can create a DC electric field for repelling ions so that the ions will not escape from the ion-capturing space 200.

The multipole RF electric field gives rise to an RF pseudo potential having an ion-confining effect. The characteristics of a linear ion trap, such as the mass dependency of the ion-confining performance or the converging power for converging ions into an area around the central axis, change depending on the number of rod electrodes, i.e., the number of poles. In normal cases, increasing the number of poles reduces the mass dependency of the confining performance (i.e., ions can be confined over a wider range of m/z), although it also reduces the converging power. Accordingly, although the hexapole configuration is used for the linear ion trap in the present embodiment, an appropriate number of poles other than six may be selected according to the desired characteristics. Specifically, an N-pole configuration in which N=6+4M (where M is 0, 1, 2, . . . ) can theoretically be adopted. In any case, the various ions originating from the sample are confined within the ion-capturing space 200 due to the effect of the RF pseudo potential created by the multipole RF electric field.

Though not shown, an inert gas, such as helium or argon, can be supplied through an inert gas introduction tube into the linear ion trap 2. The various ions captured within the ion-capturing space 200 come in contact with the inert gas and lose kinetic energy. In other words, the various ions are cooled within the ion-capturing space 200, which reduces the spread of the ions in the longitudinal direction (Z-axis direction) as well as helps the ions to exist near the ion beam axis C.

For example, when the target ion is a positive ion, the polarity of the DC voltage applied to the extracting electrode 23 for accumulating and cooling ions is the same as that of the ions, i.e., positive, as shown in FIG. 6. Due to the combination of the confining effect of the RF pseudo potential and that of the electric field created by the DC voltages respectively applied to the entrance end-cap electrode 22 and the extracting electrode 23, the ions are satisfactorily confined within the ion-capturing space 200.

After the cooling of the ions has been performed for a predetermined period of time, the extracting DC volage applied to the extracting electrode 23 is switched from the polarity of the ions to the opposite polarity (in the present case, negative), as shown in FIG. 6. The electric field created by this negative DC voltage has an ion-attracting effect, which reaches into the ion-capturing space 200 through the ion extraction opening 210 including the removed portions 212a and 213a. Accordingly, when ions are captured within the ion-capturing space 200 by the multipole RF electric field in the previously described manner, those ions also experience the force originating from the DC electric field. However, in this situation, the ions can stay within the ion-capturing space 200 since the confining effect by the RF pseudo potential exceeds the force acting on the ions due to the DC electric field.

Simultaneously with or immediately after the switching of the polarity of the extracting DC voltage, the RF power supply 50 changes the RF voltages applied to the rod electrodes 201-206 so that their amplitude gradually decreases. The strength of the ion-confining effect by the RF pseudo potential within the linear ion trap is inversely proportional to the mass of the ion. That is to say, an ion having a larger m/z value experiences a lesser confining effect from the RF pseudo potential and is easier to leave the ion-capturing space 200. Therefore, when the RF voltages applied to the rod electrodes 201-206 are changed so that their amplitude gradually decreases, the binding force acting on the ions becomes weaker in descending order of their m/z, starting from ions having larger m/z. On the other hand, the extracting DC electric field created by the extracting electrode 23 equally acts on all ions, regardless of their individual mass. Therefore, the ions are sequentially attracted by the extracting DC electric field in order of the decrease in the binding force due to the RF pseudo potential, i.e., in descending order of the m/z of the ions, and pass through the ion extraction opening 210 and the opening 23a of the extracting electrode 23, to be extracted to the outside roughly in the Z-axis direction (along the ion beam axis C).

As shown in FIG. 6, when the RF voltages are changed so that their amplitude gradually decreases while the extracting DC voltage is maintained at a constant value, the ions captured within the ion-capturing space 200 of the linear ion trap 2 are sequentially ejected in descending order of their m/z through the ion extraction opening 201 and the opening 23a. That is to say, a mass scan is achieved in which the m/z of the ions extracted from the linear ion trap 2 gradually decreases.

In place of the previously described operation in which the amplitude of the RF voltages is gradually decreased, an operation as shown in FIG. 7 may be performed in which the voltage value of the DC voltage applied to the extracting electrode 23 is changed so as to gradually strengthen the extracting DC electric field while the amplitude of the RF voltages is maintained at a constant value, i.e., while the ion-confining effect by the RF pseudo potential is constantly maintained. This also enables a mass scan in which the m/z of the ions extracted from the ion-capturing space 200 gradually decreases as in the case of varying the amplitude of the RF voltages in the previously described manner.

It should be noted that gradually changing the extracting DC voltage for the mass scan as in the example of FIG. 7 causes a corresponding change in the amount of energy possessed by the ions after they have passed through the extracting electrode 23. Accordingly, the present control system should preferably be used in the case where this change in energy does not cause any issue. By comparison, as will be described later, for example, when the linear ion trap is placed within a collision cell in a Q-TOF mass spectrometer, it is preferable that the kinetic energy of the ions ejected from the linear ion trap be constantly maintained regardless of the m/z value. In that case, the control system as shown in FIG. 6 can be adopted in which the mass scan is performed by varying the amplitude of the RF voltages rather than the extracting DC voltage.

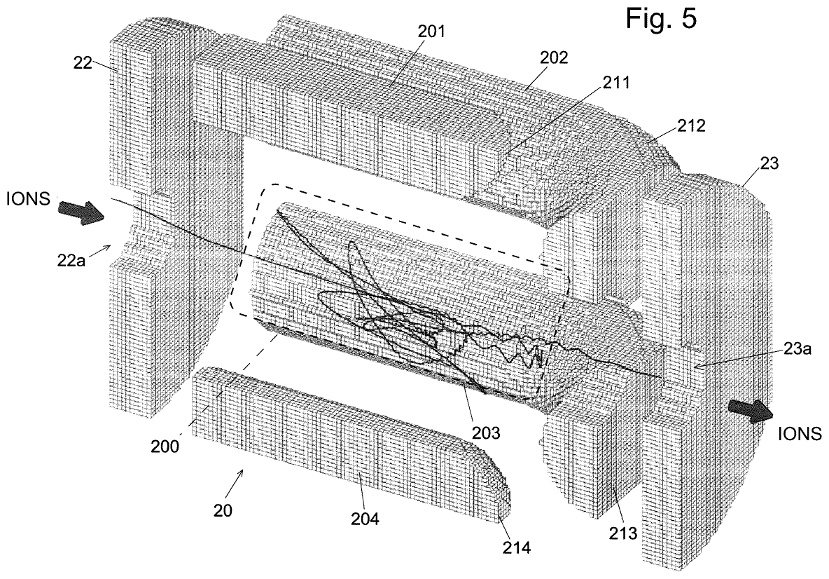

FIG. 5 is one example of the result of a simulation of the trajectory of an ion from the introduction of the ion into the ion-capturing space 200 of the linear ion trap 2 to the extraction of the same ion to the outside. The present example shows the trajectory of a single ion for ease of understanding of the ion trajectory.

As can be seen in FIG. 5, ions enter the ion-capturing space 200 through the opening 22a of the entrance end-cap electrode 22 and are accumulated within the ion-capturing space 200 while being cooled through collision with the gas which is present within the same space. In this situation, a DC voltage effectively identical to the voltage applied to the entrance end-cap electrode 22 is applied to the extracting electrode 23. At the timing to extract ions, the polarity of the DC voltage applied to the extracting electrode 23 is switched, and the amplitude of the extracting DC voltage is increased so as to gradually strengthen the extracting electric field, or the amplitude of the RF voltages is gradually decreased, whereby the ions are axially extracted through the opening 23a to the outside in descending order of their m/z.

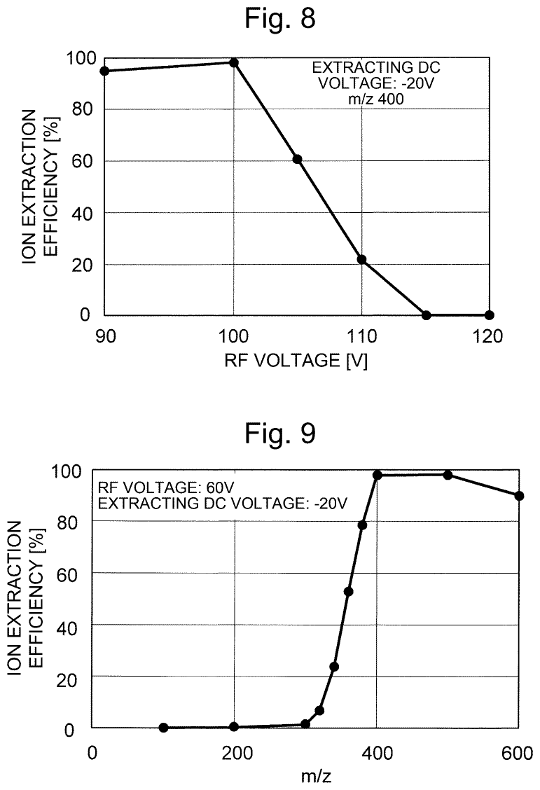

FIGS. 8 and 9 are graphs showing the results of simulated calculations of the ion extraction efficiency from the linear ion trap 2. The graph in FIG. 8 shows the relationship between the amplitude value of the RF voltages and the ion extraction efficiency when the extracting DC voltage was constantly maintained at −20 V. Only an ion of m/z 400 was considered as the target in this simulation. The graph in FIG. 9 shows the relationship between the m/z value of the ions and the extraction efficiency when the amplitude of the RF voltages and the value of the extracting DC voltage were constantly maintained.

In FIGS. 8 and 9, an ion extraction efficiency of 0% means that ions are confined in a stable state within the ion-capturing space 200. On the other hand, an ion extraction efficiency of 100% means that no ion can be present in a stable state within the ion-capturing space 200, and therefore all ions will be extracted. From FIG. 8, it can be understood that the ion of m/z 400 was not extracted when the amplitude of the RF voltages was at 120 V while the extracting DC voltage was constantly maintained at −20 V. As the amplitude of the RF voltages was gradually decreased from approximately 115 V, the ion of m/z 400 began to be extracted, and the amount of extraction gradually increased. When the amplitude of the RF voltages was approximately equal to or smaller than 100 V, the ion of m/z 400 was almost entirely extracted, i.e., ejected.

As noted earlier, the ion-confining performance by the RF pseudo potential is inversely proportional to the mass of the ion. From FIG. 9, it can be confirmed that the effect as expected from the principle was obtained: ions having higher masses are more easily ejected when the voltage condition is the same, and the device acts as a high-pass mass filter. The mass selectivity exhibited under the voltage condition shown in FIG. 9 is such that ions with m/z equal to or higher than 400 can be almost entirely ejected while most of ions with m/z equal to or lower than 300 are retained within the ion-capturing space 200. This mass selectivity can be further improved by optimizing the gas pressure (which affects the ion-cooling), amplitude of the RF voltage, extracting DC voltage and other related parameters.

It should be noted that the decreasing tendency of the extraction efficiency for ions with m/z equal to or higher than 500 in FIG. 9 is due to the loss of ions during the accumulation process in the ion-capturing space 200. This is most likely due to the fact that the ion-confining power due to the RF pseudo potential decreases with increasing m/z. An effective measure for improving the ion-confining power is to increase the number of poles of the multipole field. Accordingly, when the supply of ions having high m/z needs to be particularly increased, it is preferable to increase the number of poles of the linear ion trap, i.e., the number of rod electrodes.

Thus, the gas pressure, number of poles of the multipole field, amplitude of the RF voltage, extracting DC voltage and other parameters affect the performance of the linear ion trap 2. One of the features of this linear ion trap is that the values of those parameters can be combined and modified in an appropriate manner to perform a flexible ion operation according to specific purposes.

### First Configuration Example of Mass Spectrometer

A specific configuration example of the previously described mass spectrometer is hereinafter described.

There are various types of mass separators used in mass spectrometers, among which quadrupole mass filters are currently most commonly used. Tandem mass spectrometers also use quadrupole mass filters, as in a triple quadrupole mass spectrometer, quadrupole time-of-flight mass spectrometer or quadrupole Fourier transform mass spectrometer.

Quadrupole mass filters are certainly easy-to-use mass separators. However, since this type of mass separator is configured to selectively allow only an ion having a specific m/z (or ions within a certain range of m/z) to pass through, there is the problem that a considerable amount of ions having other m/z values that are not allowed to pass through will be wasted. In other words, the ion utilization efficiency in a quadrupole mass filter is not always high.

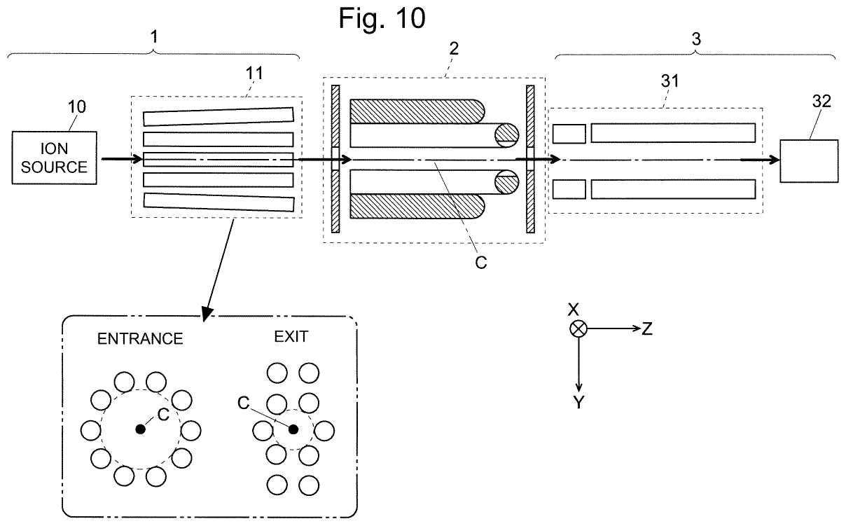

The previously described linear ion trap can be used to solve this problem. FIG. 10 is a schematic configuration diagram of a mass spectrometer according to the first configuration example.

The mass spectrometry-detection unit 3 in this mass spectrometer includes a quadruple mass filter 31 and an ion detector 32, with the linear ion trap 2 having the previously described configuration located before the quadrupole mass filter 31. The ion supply unit 1 includes an ion source 10 and a pole-number conversion ion guide 11. Ions released from the pole-number conversion ion guide 11 are introduced into the linear ion trap 2. In the present example, the ion beam axes C of the pole-number conversion ion guide 11, linear ion trap 2 and quadrupole mass filter 31 are coincident with each other; i.e., they are located in a straight line.

The pole-number conversion ion guide 11, an example of which is a multipole ion guide disclosed in Patent Literature 4, is an ion guide in which at least some of the rod electrodes are arranged to be inclined to the straight ion beam axis C so that the number of poles at the ion entrance end of the guide differs from the number of poles at the ion exit end. In the present example, 10 rod electrodes are used in such a manner that a decapole arrangement in which the 10 rod electrodes are arranged at substantially equal angular intervals around the ion beam axis C is formed at the ion entrance end, while a hexapole arrangement in which only six of the 10 rod electrodes are arranged at substantially equal angular intervals around the ion beam axis C is formed at the ion exit end.

As with the linear ion trap 2, the ion-confining power of the multipole ion guide also becomes stronger as the number of poles becomes larger. Therefore, the arrangement with the larger number of poles at the ion entrance end can efficiently capture a gradually spreading beam of ions coming from the previous stage (in FIG. 10, the ion source 10) into the inner space of the pole-number conversion ion guide 11. On the other hand, a smaller number of poles means a stronger ion-converging effect. Therefore, the arrangement with the smaller number of poles at the ion exit end can converge ions into an area around the ion beam axis C and send them to the subsequent stage (in FIG. 10, the linear ion trap 2) without waste. Additionally, in the pole-number conversion ion guide 11, an axial electric field for transporting (i.e., accelerating) ions in their direction of travel can be created by a DC voltage applied to each rod electrode.

The reason for the hexapole arrangement at the ion exit end of the pole-number conversion ion guide 11 in the present configuration is to make the number of poles at the ion exit end of the pole-number conversion ion guide 11 equal to that of the poles of the linear ion trap 2 in order to equalize the mass selectivity of the multipole RF electric field. However, this is not essential.

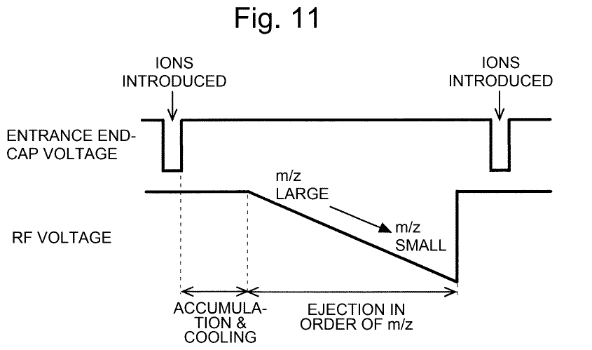

With reference to the timing chart shown in FIG. 11, a typical operation of the present mass spectrometer is hereinafter described. Ions originating from a sample component produced in the ion source 10 are introduced into the pole-number conversion ion guide 11. As described earlier, an axial electric field in the direction of travel of the ions and a multipole RF electric field are created within the inner space of the pole-number conversion ion guide 11. These electric fields cause the ions to travel toward the exit end while being converged. To the entrance end-cap electrode 22 of the linear ion trap 2, a DC voltage whose electric potential acts as a barrier against the ions is normally applied. Therefore, the ions which have arrived in an exit area of the pole-number conversion ion guide 11 are blocked in front of the entrance end-cap electrode 22, being accumulated within the exit area of the pole-number conversion ion guide 11.

As shown in FIG. 11, the voltage applied the entrance end-cap electrode 22 is temporarily lowered at a predetermined timing. Only during this period of time, the potential barrier disappears, and the ions accumulated in the exit area of the pole-number conversion ion guide 11 are introduced through the opening 22a into the ion-capturing space 200 of the linear ion trap 2. Thus, the transfer of the ions from the pole-number conversion ion guide 11 to the linear ion trap 2 is carried out in a packet-like form. After all accumulated ions have been transferred, the voltage applied to the entrance end-cap electrode 22 is once more increased to the normal level, whereupon the accumulation of ions in the exit area of the pole-number conversion ion guide 11 begins. Accumulating ions in the exit area of the pole-number conversion ion guide 11 in this manner prevents the loss of the ions continuously supplied from the ion source 10 and allows the ions to be efficiently introduced into the linear ion trap 2 even when the period of time during which ions can be introduced into the linear ion trap 2 is limited.

The ions introduced into the ion-capturing space 200 are cooled through their contact with gas and satisfactorily captured, as described earlier. Subsequently, as the amplitude of the RF voltages applied to the rod-electrode group 20 is gradually decreased, the captured ions are extracted in descending order of their m/z, through the opening 23a of the extracting electrode 23, along the ion beam axis C. During this process, the scan of the RF voltages applied to the rod-electrode group 20 of the linear ion trap 2 is synchronously controlled with the scan of the voltage applied to the quadrupole mass filter 31 (which is a voltage composed of an RF voltage and a DC voltage superposed on each other) so that the ion having a predetermined m/z to be ejected from the linear ion trap 2 coincides with the m/z of the ion to be selected by the quadrupole mass filter 31 in the subsequent stage, i.e., to be allowed to pass through the quadrupole mass filter 31.

In a conventional quadrupole mass spectrometer in which a quadrupole mass filter is used as a mass separator, when a mass scan is performed with the quadrupole mass filter, the ion utilization efficiency is not always high since ions other than those which are allowed to pass through the quadrupole mass filter are wasted. By comparison, in the mass spectrometer according to the first configuration example, among the ions accumulated in the linear ion trap 2, only ions having m/z values which are mostly allowed to pass through the quadrupole mass filter 31 are selectively ejected from the linear ion trap 2 and sent into the quadrupole mass filter 31. Therefore, ions which would be lost in the quadrupole mass filter in the conventional case can also be effectively used. This enables the device to achieve a higher level of sensitivity than the conventional quadrupole mass spectrometer. Furthermore, even when an ion having a specific m/z has been transiently generated, the ion is unlikely to be overlooked since most of the ions originating from a sample component produced in the ion source 10 can be subjected to the mass spectrometric analysis. This is useful for exhaustively grasping the ions originating from a sample component.

The first configuration example is a single type of quadrupole mass spectrometer. As another possible configuration, the linear ion trap 2 may be placed before the first quadrupole mass filter in a triple quadrupole mass filter capable of an MS/MS analysis. In that case, for example, when a mass scan is performed using the first quadrupole mass filter as in the case of a precursor ion scan measurement or neutral loss scan measurement, the linear ion trap 2 and the first quadrupole mass filter can be synchronously controlled so that the m/z of the ion ejected from the linear ion trap 2 becomes approximately equal to the m/z of the ion to be allowed to pass through the first quadrupole mass filter.

### Second Configuration Example of Mass Spectrometer

In a Q-TOF mass spectrometer having a collision cell located between a quadrupole mass filter and an orthogonal acceleration time-of-flight mass separator, various product ions can be produced from a single kind of precursor ion in the collision cell. However, the period of time required for each of the ions almost simultaneously ejected from the collision cell to reach the orthogonal accelerator varies depending on the m/z of the ion. Therefore, when ions are accelerated in a pulsed fashion in the orthogonal accelerator, there is the case where only specific kinds of product ions falling within a limited m/z range can be accelerated among the product ions of various m/z originating from a single precursor ion. In that case, there is the problem that an accurate product ion spectrum cannot be obtained due to the limited m/z range of the observable product ions.

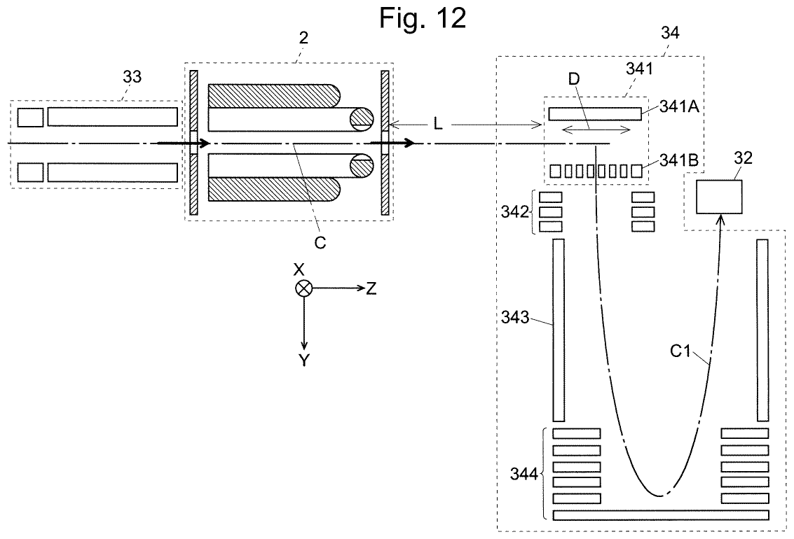

The mass spectrometer according to the second configuration example uses the previously described linear ion trap 2 to solve the previously described problem. FIG. 12 is a schematic configuration diagram of the mass spectrometer according to the second configuration example.

The mass spectrometry-detection unit 3 in the present mass spectrometer includes a quadruple mass filter 33, orthogonal acceleration time-of-flight mass separator 34 and ion detector 32, with the linear ion trap 2 having the previously described configuration located within a collision cell (not shown) between the quadruple mass filter 33 and the orthogonal acceleration time-of-flight mass separator 34. It should be noted that the component corresponding to the previously described ion supply unit 1 is omitted in FIG. 12. The orthogonal acceleration time-of-flight mass separator 34 includes an orthogonal accelerator 341 which includes a push-out electrode 341A and a pulling electrode 341B paired with each other, as well as an accelerating electrode 342, flight tube 343 and reflecting electrode 344.

The quadrupole mass filter 33 selectively allows an ion having a specific m/z to pass through among the ions supplied from the ion supply unit (not shown). This ion is introduced into the ion-capturing space 200 of the linear ion trap 2 and undergoes dissociation by coming in contact with collision gas supplied into the ion-capturing space 200, whereby various product ions are generated. The resulting product ions are captured within the ion-capturing space 200 by the RF electric field. Subsequently, while the extracting DC voltage is constantly maintained, the RF voltages applied to the rod-electrode group 20 are changed, whereby the product ions captured within the ion-capturing space 200 are ejected in descending order of their m/z through the ion extraction opening 210 and the opening 23a. The ejected ions travel roughly along the ion beam axis C and reach the orthogonal accelerator 341.

When the extracting DC voltage is maintained at a constant value, the ions ejected from the linear ion trap 2 due to the effect of the extracting DC electric field created by that voltage are given an equal amount of energy regardless of their respective m/z. Therefore, an ion having a smaller m/z and ejected at a later point in time travels at a higher speed than an ion having a larger m/z and ejected at an earlier point in time. Therefore, by appropriately controlling the change in the RF voltages, it is possible to cause all ions having different m/z values and ejected from the linear ion trap 2 in a temporally separated fashion to almost simultaneously arrive at a predetermined position within the orthogonal accelerator 341.

In the orthogonal acceleration time-of-flight mass separator 34, ions are introduced into the orthogonal accelerator 341 along the ion beam axis C in the Z-axis direction. At the timing at which the various ions of different m/z have almost simultaneously entered the orthogonal accelerator 341 in the previously described manner, a DC voltage in the form of a predetermined pulse is applied to each of the push-out and pulling electrodes 341A and 341B. Then, the ions having various m/z and travelling within the orthogonal accelerator 341 at the moment are pushed out through the slit of the pulling electrode 341B in the Y-axis direction and subsequently accelerated by the accelerating electrode 341, to be ejected into the flight tube 343.

The ions fly within the flight tube 343 and after being repelled by the electric field created by the reflecting electrode 344, they once more fly within the flight tube 343. The ions which have travelled along the return path C1 in this manner ultimately arrive at and are detected by the ion detector 32. Since the ions almost simultaneously ejected from the orthogonal accelerator 341 travel with different times of flight according to their respective m/z, those ions are separated from each other in the course of their travel and arrive at the ion detector 32 in ascending order of their m/z.

Thus, in the mass spectrometer according to the second configuration example, ions having a wide range of m/z supplied from the linear ion trap 2 can be sent into the flight space without waste and subjected to a mass spectrometric analysis. Accordingly, product ions having a wide range of m/z can be detected with a high level of sensitivity.

In the present mass spectrometer, in order to cause all ions ejected from the linear ion trap 2 toward the orthogonal accelerator 341 to almost simultaneously arrive at a predetermined position within the orthogonal accelerator 341 in the previously described manner, the extraction of the ions from the linear ion trap 2 should preferably be controlled under the following conditions.

As shown in FIG. 12, the distance from the extracting electrode 23 to the orthogonal accelerator 341 is L, and the length of the ion passage area in the orthogonal accelerator 341 is D. The space from the extracting electrode 23 to the orthogonal accelerator 341 is an equipotential space. The amount of energy possessed by an ion extracted from the linear ion trap 2 is given by eV_{E} on the assumption that the ion starts from a sufficiently cooled state and is accelerated by an extracting DC voltage V_{E}. Now, suppose that the ion does not collide with any neutral particle within the space from the extracting electrode 23 to the orthogonal accelerator 341. In the conventional technique in which all ions are almost simultaneously extracted from the ion trap, the time t at which an ion having the lowest mass m₁ arrives at the exit of the orthogonal accelerator 341 is expressed by the following equation (1):

$$t = ( D + L ) √ ( {m}_{1} / 2 e {V}_{E} ) \qquad ( 1 )$$

An ion which arrives at the entrance of the orthogonal accelerator 341 at that point in time has the highest mass m₂ that can be simultaneously observed. Its arrival time t is given by the following equation (2):

$$t = D √ ( {m}_{1} / 2 e {V}_{E} ) \qquad ( 2 )$$

Accordingly, the mass range of the observable ions is expressed by the following equation (3):

$${m}_{2} / {m}_{1} = {\{ ( D + L ) / D \}}^{2} \qquad ( 3 )$$

By comparison, in the case of using the linear ion trap 2 which ejects ions in descending order of m/z in the previously described manner, since a heavier ion can be released at an earlier point in time, it is possible to control the device so that this heavier ion and a lighter ion released at a later point in time simultaneously arrive at a specific position in the orthogonal accelerator 341. Consider the case where all ions of different masses should arrive at the center of the orthogonal accelerator 341. The arrival time of the ion having the highest mass m₂ is given by:

$$t = \{ D + ( L / 2 ) \} √ ( {m}_{2} / 2 e {V}_{E} ) \qquad ( 4 )$$

The delay time t_{D} in the RF-voltage control necessary for causing this ion and the ion having the lowest mass m₁ to simultaneously arrive at the central position is given by:

$${t}_{D} = \{ D + ( L / 2 ) \} \{ √ {m}_{2} - √ {m}_{1} ) / √ ( 2 e {V}_{E} ) \} \qquad ( 5 )$$

In summary, by performing the RF-voltage scan so that the extraction of the ions from the linear ion tap 2 is performed with the aforementioned delay time t_{D}, it is possible to cause almost all ions within the target mass range to almost simultaneously arrive at the same position in the orthogonal accelerator 341. This allows for not only an expansion of the mass range of the ions to be observed as compared to the conventional technique, but also for an improvement in detection sensitivity and mass resolution since the variation in the initial position of the ions in the orthogonal accelerator 341 is decreased. In this second configuration example, it is preferable to extract ions in descending order of m/z by the RF-voltage scan rather than the scan of the extracting DC voltage in order to equalize the amount of kinetic energy possessed by the ions extracted from the linear ion trap 2 as described earlier.

### Third Configuration Example of Mass Spectrometer

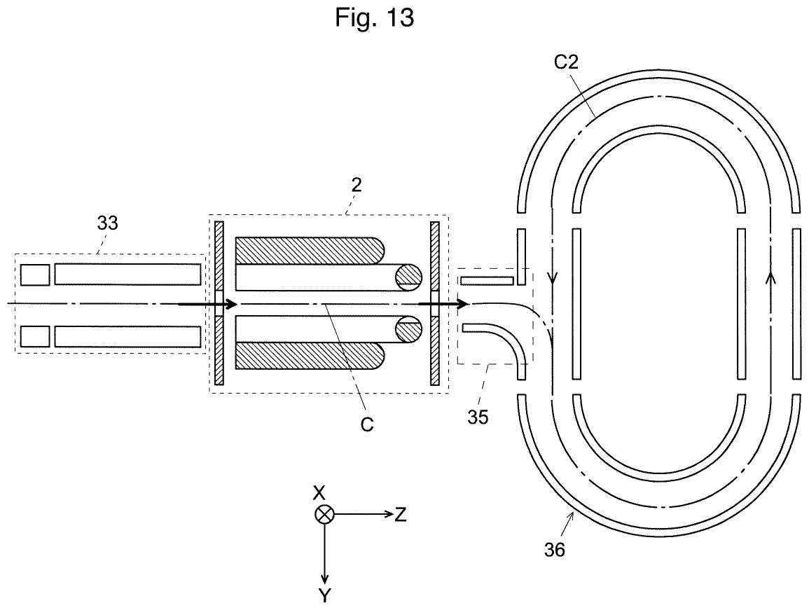

FIG. 13 is a configuration diagram of the main components of a mass spectrometer according to the third configuration example. The mass spectrometer according to the third configuration example includes a multi-turn Fourier transform mass separator 36 with the previously described linear ion trap 2 combined in the previous stage. According to this configuration, the ions ejected from the linear ion trap 2 are introduced through an ion injector 35 into the multi-turn Fourier transform mass separator 36 and fly along a loop orbit C2. The voltage applied to the electrodes forming the ion injector 35 is switched in such a manner that an injecting electric field for putting ions coming from the linear ion trap 2 in the loop orbit C2 is created during the period in which incident ions are arriving, while a looping electric field for causing the ions to fly along the loop orbit C2 is created during the period in which ions are traveling in this orbit.

In a conventional mass spectrometer of this type, ions almost simultaneously ejected from the ion trap need to be almost simultaneously put in the loop orbit C2, which requires narrowly limiting the m/z range of the ions which are simultaneously subjected to the mass spectrometric analysis. By comparison, in the mass spectrometer according to the third configuration example, similar to the second configuration example, it is possible to cause ions of all m/z to almost simultaneously arrive at a desired position on the loop orbit C2 by causing ions having larger m/z and relatively lower flight speeds to be ejected earlier from the linear ion trap 2, thereby gradually ejecting the ions in descending order of their m/z and putting them in the loop orbit C2. This allows for an expansion of the m/z range of the ions to be observed. The voltages applied to the ion injector 35 need to be switched before the first ion that completes one turn among the ions introduced through the ion injector 35 into the loop orbit C2 returns to the ion injector 35. Since ions having smaller m/z are introduced into the loop orbit C2 at later points in time than ions having larger m/z, it is possible to set a longer period of time for putting ions in the loop orbit C2 in the ion injector 35 so as to subject a larger amount of ions to the mass spectrometric analysis. This contributes to an improvement in detection sensitivity.

In the present case, the calculation of the delay time t_{D} by equation (5) can be performed using L which denotes the flight length of the ion injector 35 and D which denotes the flight length to a point at which ions should simultaneously arrive on the loop orbit C2.

### Modified Examples of Linear Ion Trap

In the linear ion trap 2 described based on FIGS. 1, 3 and others, the three-dimensional ion trap partial electrode 21 corresponds to the auxiliary electrode in the present invention and is intended to strengthen the ion-binding effect due to the multipole RF electric field at the end of the rod-electrode group 20 located on the side facing the extracting electrode 23. Without this auxiliary electrode (i.e., without the RF electric field created by the auxiliary electrode), ions having relatively small m/z and being insufficiently captured by the main RF electric field may also escape along with ions having relatively larger m/z when the extracting DC voltage is applied to the extracting electrode 23. Therefore, it is necessary that an auxiliary electrode which creates an RF electric field for preventing the escape of ions be arranged between the end of the rod-electrode group 20 and the extracting electrode 23. However, the structure and shape of this auxiliary electrode is not limited to the previously described ones.

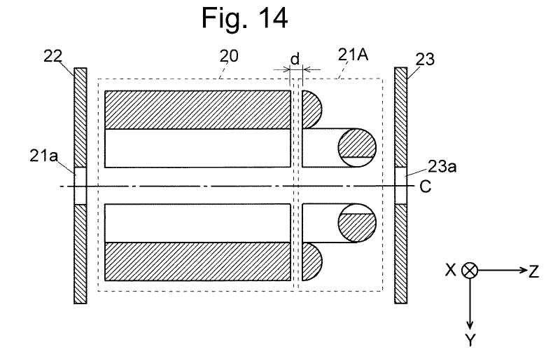

Specifically, although the electrodes of the rod-electrode group 20 in the previously described linear ion trap 2 are integrated with those of the three-dimensional ion trap partial electrode 21, they may be separated from each other. That is to say, as shown in FIG. 14, a three-dimensional ion trap partial electrode 21A which is identical in structure and shape to the previously described three-dimensional ion trap partial electrode 21 may be arranged with a predetermined space (in the present example, a gap of length d) from the end of the rod-electrode group 20. Needless to say, the electrodes forming the present three-dimensional ion trap partial electrode 21A are respectively supplied with RF voltages similar to those of the previously described examples. Additionally, in the present case, the voltages applied to the electrodes of the rod-electrode group 20 can be different from those applied to the corresponding electrodes of the three-dimensional ion trap partial electrode 21A. Therefore, the ejection of ions according to their m/z can also be performed by scanning (varying) only the RF voltages applied to the electrodes of the three-dimensional ion trap partial electrode 21A while constantly maintaining the RF voltages applied to the electrodes of the rod-electrode group 20.

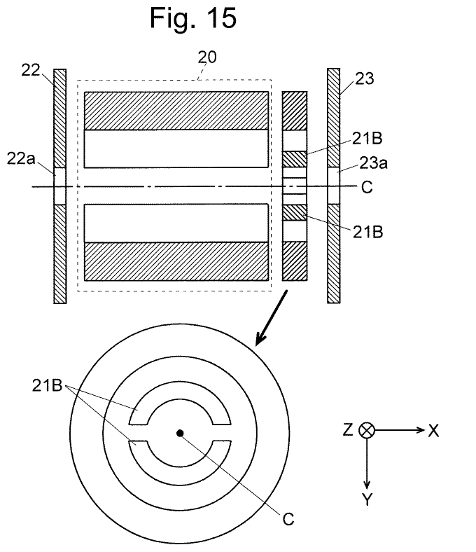

In place of the three-dimensional ion trap partial electrode 21 or 21A, an RF gate electrode 21B as shown in FIG. 15 consisting of a combination of two electrodes having a semicircular shape on a plan view may be used as the auxiliary electrode. This RF gate electrode 21B is located inside an annular electrode to which an appropriate DC voltage is applied. A pair of RF voltages with opposite phases are respectively applied to the two electrodes forming the RF gate electrode 21B. The application of these RF voltages creates a dipole RF electric field on the axis within the inner space of the RF gate electrode 21B. This dipole RF electric field acts as an RF pseudo potential barrier against ions captured within the ion-capturing space 200. This barrier prevents ions from escaping toward the extracting electrode 23 when the amplitude of the applied RF voltage is large.

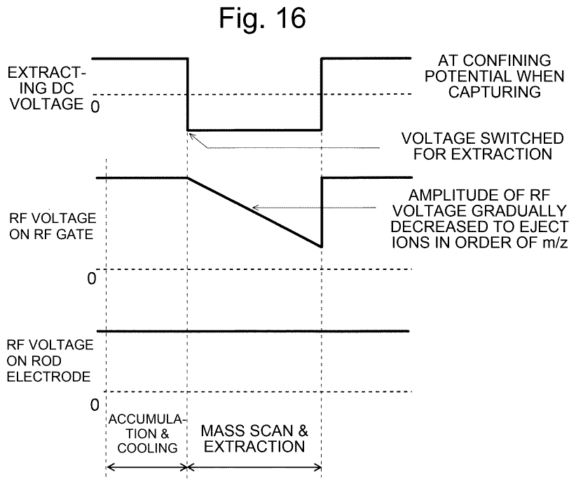

FIG. 16 is one example of the timing chart of the change in the voltages applied for driving the linear ion trap shown in FIG. 15. According to the present configuration, both the extracting DC voltage applied to the extracting electrode 23 and the amplitude of the RF voltages applied to the rod electrodes 201-206 are constantly maintained when ions are extracted from the ion-capturing space 200 in descending order of their m/z. Meanwhile, only the amplitude of the RF volage applied to the RF gate electrode 21B is gradually decreased. The RF pseudo potential barrier created by the RF gate electrode 21B has a different height depending on the mass of the ion; the larger the mass of the ion is, the easier it is to overcome the RF pseudo potential barrier. Therefore, when the amplitude of the RF voltage applied to the RF gate electrode 21B is gradually decreased, the ions are sequentially ejected through the opening 23a in descending order of m/z, as in the linear ion trap of the previously described example. Thus, the axial ejection according to m/z is achieved.

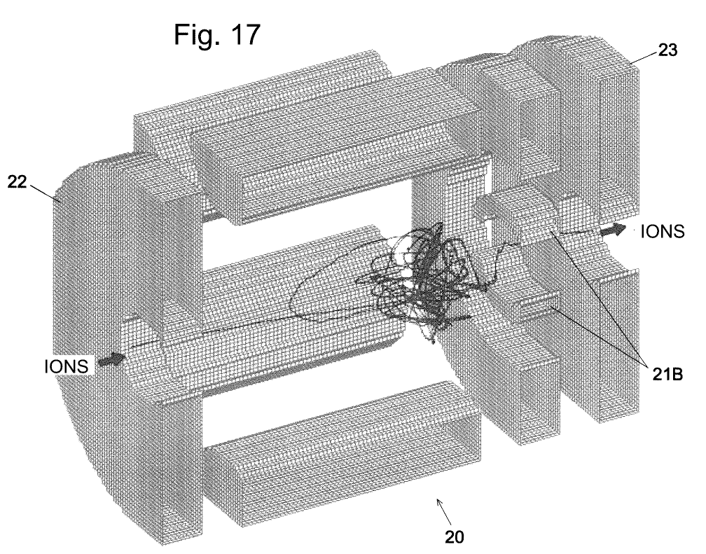

FIG. 17 shows one example of the simulation result of the trajectory of an ion from its introduction into the ion-capturing space to its extraction to the outside in the linear ion trap shown in FIG. 15. In the present case, unlike the example shown in FIG. 5, no hexapole electric field is created in the axial direction, while an RF pseudo potential barrier is created in the vicinity of the RF gate electrode 21B. Therefore, ions are captured in an area near the RF gate electrode 21B, and the captured ions are extracted to the outside in the axial direction in descending order of their m/z when, for example, the amplitude of the RF voltage is gradually decreased,

It should be noted that the previously described embodiment and configuration examples are mere examples of the present invention, and any change, addition or modification appropriately made within the spirit of the present invention will naturally fall within the scope of claims of the present application.

### VARIOUS MODES

A person skilled in the art can understand that the previously described illustrative embodiment is a specific example of the following modes of the present invention.

(Clause 1) One mode of the mass spectrometer according to the present invention includes:
a linear ion trap unit including: a plurality of rod electrodes arranged so as to surround a central axis; an auxiliary electrode surrounding the central axis, or having the central axis in between, and provided outside an ion-ejection end of the plurality of rod electrodes or protruding from the ion-ejection end; and an extracting electrode located further outside the auxiliary electrode;
an RF voltage generator configured to apply an RF voltage to the plurality of rod electrodes and the auxiliary electrode in order to create an RF electric field within an ion-capturing space surrounded by the plurality of rod electrodes and the auxiliary electrode;
an extracting voltage generator configured to apply a DC voltage to the extracting electrode so that a DC electric field for ion extraction reaches the ion-capturing space; and
a controller configured to control the RF voltage generator and the extracting voltage generator so as to eject ions from the ion-capturing space in a direction along the central axis according to the mass-to-charge ratios of the ions by changing at least the RF voltage or the DC voltage when the ions are confined within the ion-capturing space.

In the mass spectrometer according to Clause 1, only either the RF voltage applied to the rod electrodes or the DC voltage applied to the extracting electrode needs to be varied to perform a scan for extracting ions from the linear ion trap in order of their m/z. Therefore, it is unnecessary to apply two different types of alternating-current voltages, i.e., the RF and AC voltages, to the rod electrodes in a superposed form as in the case of the conventional resonance excitation ejection. Therefore, by the mass spectrometer according to Clause 1, it is possible to simplify the configuration of the power supply device for driving the linear ion trap and yet realize a mass scan for releasing ions from the linear ion trap in order of their m/z. The power supply device can consequently be smaller in size and lighter in weight, as well as less expensive. Furthermore, since ions are ejected in the axial direction of the linear ion trap, it is possible to arrange ion optical devices, such as a quadrupole mass filter or multipole ion guide, in the subsequent stages so that their ion beam axis coincides with that of the linear ion trap. This facilitates the task of arranging the ion optical devices.

(Clause 2) In the mass spectrometer according to Clause 1, the auxiliary electrode may be a multipole three-dimensional ion trap partial electrode which corresponds to a partial cutout from electrodes forming a multipole three-dimensional ion trap having the same number of poles as a linear ion trap formed by the plurality of rod electrodes.

For example, a hexapole three-dimensional ion trap partial electrode can be used as the auxiliary electrode in the case where the linear ion trap is a hexapole structure. The use of such a multipole three-dimensional ion trap partial electrode strengthens the RF electric field created at the ion-ejection end of the rod electrodes and reduces the escape of ions having m/z values different from the target m/z in the process of ejecting ions according to their m/z. Consequently, a satisfactory mass scan can be achieved.

(Clause 3) In the mass spectrometer according to Clause 2, the auxiliary electrode may be the multipole three-dimensional ion trap partial electrode having a removed portion which is a hollow formed around the central axis.

For example, consider the case where a hexapole three-dimensional ion trap partial electrode is used as the auxiliary electrode. In principle, it is possible to extract ions through the space between two ring-shaped electrodes facing each other across the central axis. However, the size of that space is not sufficient for allowing a DC electric field of sufficient strength to penetrate into the ion-capturing space. By comparison, the mass spectrometer according to Clause 3 can have a sufficiently large opening formed between two ring-shaped electrodes, through which opening a DC electric field of sufficient strength can penetrate into the ion-capturing space and satisfactorily extract ions from the ion-capturing space to the outside. This improves the ion extraction efficiency.

(Clause 4) In the mass spectrometer according to one of Clauses 1-3, the controller may be configured to change the RF electric field while constantly maintaining the DC electric field, to sequentially eject ions captured within the ion-capturing space in descending order of mass-to-charge ratio.

In order to sequentially extract ions in order of their mass-to-charge ratios, whichever of the DC and RF electric fields may be changed. However, it should be noted that changing the DC electric field means that the amount of energy possessed by the ions varies depending on their respective mass-to-charge ratios since the energy imparted to the ions in the ion extraction process originates from the DC electric field. This is inconvenient, for example, in the case where ions ejected from the linear ion trap at different points in time should simultaneously arrive at a specific position as will be described later. By comparison, in the mass spectrometer according to Clause 4, all ions to be extracted are given equal amounts of energy, so that the travelling speed of each ion simply depends on its mass-to-charge ratio. This is convenient for adjusting the arrival position of the ions.

(Clause 5) In the mass spectrometer according to one of Clauses 1-4:
a mass filter may be located subsequently to the linear ion trap unit;
the controller may be configured to synchronously control the RF voltage and/or the DC voltage with a voltage applied to the mass filter, in such a manner that the mass-to-charge ratio of an ion to be ejected from the ion-capturing space coincides with the mass-to-charge ratio of an ion to be allowed to pass through the mass filter.

In the mass spectrometer according to Clause 5, an ion having an m/z that is allowed to pass through the mass filter is ejected from the linear ion trap in the previous stage and introduced into the mass filter. In other words, an ion having m/z that is not allowed to pass through the mass filter is retained within the linear ion trap until the point in time where that ion is allowed to pass through the mass filter. Accordingly, in the mass spectrometer according to Clause 5, the ions rejected by the mass filter are decreased and the generated ions are efficiently used, so that the detection sensitivity can be improved.

(Clause 6) In the mass spectrometer according to one of Clauses 1-4, the linear ion trap unit may include an entrance end-cap electrode located outside an ion-injection end opposite from the ion-ejection end of the plurality of rod electrodes, and the mass spectrometer may further include:
an entrance voltage generator configured to apply, to the entrance end-cap electrode, a voltage for allowing ions to pass through and a voltage for blocking ions in a switchable manner; and
a pole-number conversion ion guide located before the linear ion trap unit and configured to create a multipole field whose number of poles is different between an ion entrance end and an ion exit end,
where ions are accumulated in an exit area of the pole-number conversion ion guide during a period of time where the entrance voltage generator is applying the voltage for blocking ions to the entrance end-cap electrode.

In the mass spectrometer according to Clause 6, although the introduction period during which ions can be introduced from the pole-number conversion ion guide into the linear ion trap is limited, the ions transferred by the pole-number conversion ion guide during a period of time other than the introduction period are accumulated in the exit area of the ion guide and will be introduced into the linear ion trap in the next introduction period. Therefore, even in the case where ions are continuously transferred by the pole-number conversion ion guide, those ions will be assuredly introduced into the linear ion trap without being wasted. This increases the amount of ions to be subjected to a mass spectrometric analysis and thereby improves the detection sensitivity. Furthermore, an ion which is only transiently generated is unlikely to be overlooked in the detection process, so that an accurate analysis is possible.

(Clause 7) In the mass spectrometer according to one of Clauses 1-4, the controller may be configured to regulate the speed of the change in the RF voltage and/or the DC voltage or the period of time required for that change so that all ions ejected from the linear ion trap unit or ions falling within a specific mass-to-charge-ratio range among the ejected ions simultaneously arrive at a predetermined position at a predetermined distance from the linear ion trap unit.

When ions are ejected from a linear ion trap in descending order of their m/z under the condition that all ions are given equal amounts of energy, an ion having a larger m/z has a lower speed, so that an ion having a smaller m/z and ejected at a later point in time will catch up with an ion having a larger m/z and ejected at an earlier point in time. Therefore, it is possible to cause all ions to almost simultaneously arrive at a specific position, for example, by regulating the speed of the change in the RF voltage or the period of time required for that change so that an appropriate change occurs in the RF electric field, while constantly maintaining the DC voltage for extracting ions. This is convenient in the case where various ions having different m/z should start their flight from substantially the same position, or more specifically, for example, in the case where ions are ejected from an orthogonal accelerator in an orthogonal acceleration time-of-flight mass separator, or in the case where ions should simultaneously start their flight from a specific position on a loop orbit in a Fourier transform mass separator.

(Clause 8) In the mass spectrometer according to Clause 7, an orthogonal acceleration time-of-flight mass separator may be located subsequently to the linear ion trap unit, and the predetermined position may be a predetermined position within an orthogonal accelerator in the orthogonal acceleration time-of-flight mass separator.

In the mass spectrometer according to Clause 8, ions having a wide range of m/z can be almost simultaneously ejected from the orthogonal accelerator, so that the range of the m/z of the ions to be observed can be widened. Furthermore, the detection sensitivity can be improved by subjecting a larger amount of ions to the mass spectrometric analysis.

(Clause 9) In the mass spectrometer according to Clause 7, a Fourier transform mass separator may be located subsequently to the linear ion trap unit, and the predetermined position may be a predetermined position on an ion path in the Fourier transform mass separator.

In the mass spectrometer according to Clause 9, ions having a wide range of m/z can be introduced into the Fourier transform mass separator, so that the range of the m/z of the ions to be observed can be widened. Furthermore, the detection sensitivity can be improved by subjecting a larger amount of ions to the mass spectrometric analysis.

### REFERENCE SIGNS LIST

1 . . . Ion Supply Unit
10 . . . Ion Source
11 . . . Pole-Number Conversion Ion Guide
2 . . . Linear Ion Trap
20 . . . Rod-Electrode Group
200 . . . Ion-Capturing Space
201, 202, 203, 204, 205, 206 . . . Rod Electrode
21, 21A . . . Three-Dimensional Ion Trap Partial Electrode
210 . . . Ion Extraction Opening
211, 214 . . . Ball-Shaped Electrode
212, 213 . . . Ring-Shaped Electrode
212a, 213a . . . Removed Portion
21B . . . RF Gate Electrode
22 . . . Entrance End-Cap Electrode
22a, 23a . . . Opening
23 . . . Extracting Electrode
3 . . . Mass Spectrometry-Detection Unit
31, 33 . . . Quadrupole Mass Filter
32 . . . Ion Detector
34 . . . Orthogonal Acceleration Time-of-Flight Mass Separator
341 . . . Orthogonal Accelerator
342 . . . Accelerating Electrode
343 . . . Flight Tube
344 . . . Reflecting Electrode
35 . . . Ion Injector
36 . . . Multiturn Fourier Transform Mass Separator
4 . . . Control Unit
5 . . . Power Unit
50 . . . RF Power Supply
51 . . . Entrance Electrode DC Power Supply
52 . . . Extracting Electrode DC Power Supply
C . . . Ion Beam Axis
C1 . . . Return Path
C2 . . . Loop Orbit

1. A mass spectrometer, comprising:
a linear ion trap unit including: a plurality of rod electrodes arranged so as to surround a central axis; an auxiliary electrode surrounding the central axis, or having the central axis in between, and provided outside an ion-ejection end of a plurality of rod electrodes or protruding from the ion-ejection end; and an extracting electrode located further outside the auxiliary electrode;
an RF voltage generator configured to apply an RF voltage to the plurality of rod electrodes and the auxiliary electrode in order to create an RF electric field within an ion-capturing space surrounded by the plurality of rod electrodes and the auxiliary electrode;
an extracting voltage generator configured to apply a DC voltage to the extracting electrode so that a DC electric field for ion extraction reaches the ion-capturing space; and
a controller configured to control the RF voltage generator and the extracting voltage generator so as to eject ions from the ion-capturing space in a direction along the central axis according to the mass-to-charge ratios of the ions by changing at least the RF voltage or the DC voltage when the ions are confined within the ion-capturing space.

2. The mass spectrometer according to claim 1, wherein the auxiliary electrode is a multipole three-dimensional ion trap partial electrode which corresponds to a partial cutout from electrodes forming a multipole three-dimensional ion trap having a same number of poles as a linear ion trap formed by the plurality of rod electrodes.

3. The mass spectrometer according to claim 2, wherein the auxiliary electrode is the multipole three-dimensional ion trap partial electrode having a removed portion which is a hollow formed around the central axis.

4. The mass spectrometer according to claim 1, wherein the controller is configured to change the RF electric field while constantly maintaining the DC electric field, to sequentially eject ions captured within the ion-capturing space in descending order of mass-to-charge ratio.

5. The mass spectrometer according to claim 1, wherein:
a mass filter is located subsequently to the linear ion trap unit;
the controller is configured to synchronously control the RF voltage and/or the DC voltage with a voltage applied to the mass filter, in such a manner that a mass-to-charge ratio of an ion to be ejected from the ion-capturing space coincides with a mass-to-charge ratio of an ion to be allowed to pass through the mass filter.

6. The mass spectrometer according to claim 1, wherein:
the linear ion trap unit includes an entrance end-cap electrode located outside an ion-injection end opposite from the ion-ejection end of the plurality of rod electrodes; and
the mass spectrometer further includes:
an entrance voltage generator configured to apply, to the entrance end-cap electrode, a voltage for allowing ions to pass through and a voltage for blocking ions in a switchable manner; and
a pole-number conversion ion guide located before the linear ion trap unit and configured to create a multipole field whose number of poles is different between an ion entrance end and an ion exit end,
where ions are accumulated in an exit area of the pole-number conversion ion guide during a period of time where the entrance voltage generator is applying the voltage for blocking ions to the entrance end-cap electrode.

7. The mass spectrometer according to claim 1, wherein the controller is configured to regulate a speed of a change in the RF voltage and/or the DC voltage or a period of time required for that change so that all ions ejected from the linear ion trap unit or ions falling within a specific mass-to-charge-ratio range among the ejected ions simultaneously arrive at a predetermined position at a predetermined distance from the linear ion trap unit.

8. The mass spectrometer according to claim 7, wherein:
an orthogonal acceleration time-of-flight mass separator is located subsequently to the linear ion trap unit; and
the predetermined position is a predetermined position within an orthogonal accelerator in the orthogonal acceleration time-of-flight mass separator.

9. The mass spectrometer according to claim 7, wherein:
a Fourier transform mass separator is located subsequently to the linear ion trap unit; and
the predetermined position is a predetermined position on an ion path in the Fourier transform mass separator.
